(19) United States
(12) Patent Application Publication
(10) Pub. No.: US 2017/0114218 A1
(43) Pub. Date: Apr. 27, 2017

(54) RESIN COMPOSITION AND RESIN MOLDED ARTICLE

(71) Applicant: FUJI XEROX CO., LTD., Tokyo (JP)

(72) Inventor: Akira IMADA, Kanagawa (JP)

(73) Assignee: FUJI XEROX CO., LTD., Tokyo (JP)

(21) Appl. No.: 15/142,301

(22) Filed: Apr. 29, 2016

(30) Foreign Application Priority Data
Oct. 26, 2015 (JP) 2015-210045

(51) Int. Cl. C08L 69/00

(52) U.S. Cl. CPC C08L 69/00

(57) ABSTRACT

There is provided a resin composition containing a polycarbonate resin, a polyethylene terephthalate resin, a glycidyl-group-containing polyethylene copolymer, a vinyl acetate-ethylene copolymer, an organic phosphorus flame retardant, and a flame-retardant anti-drip agent, wherein the amounts of the polycarbonate resin and polyethylene terephthalate resin are approximately from 60 mass % to 90 mass % and approximately from 10 mass % to 40 mass % relative to the total amount of these resins, respectively, the glycidyl-group-containing polyethylene copolymer contains a glycidyl-group-containing (meth)acrylate unit and an ethylene unit, the glycidyl-group-containing (meth)acrylate unit content in the glycidyl-group-containing polyethylene copolymer is approximately from 2 mass % to 20 mass %, and the glycidyl-group-containing polyethylene copolymer is a polyethylene copolymer having a glass transition temperature of approximately 0° C. or lower or a copolymer in which a polymerizable vinyl monomer has been graft-polymerized with the main chain of a polyethylene copolymer containing a glycidyl-group-containing (meth)acrylate unit and an ethylene unit.

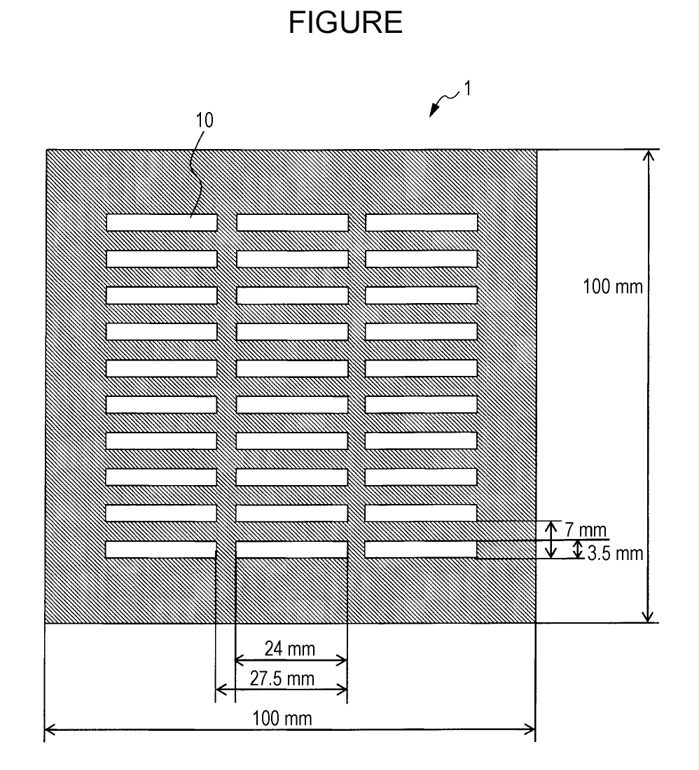

### CROSS-REFERENCE TO RELATED APPLICATIONS

This application is based on and claims priority under 35 USC 119 from Japanese Patent Application No. 2015-210045 filed Oct. 26, 2015.

### BACKGROUND

(i) Technical Field

The present invention relates to a resin composition and a resin molded article.

(ii) Related Art

A variety of resin compositions have been available and used in various applications. They are, for example, used in resin molded articles such as the parts and cases of household electric appliances and automobiles and the housings of office equipment and electronic and electrical equipment.

Polycarbonate resins are thermoplastic resins having an excellent impact resistance and heat resistance and are widely used in resin molded articles such as parts and cases in the field of machinery, automobiles, electrics, and electronics. Meanwhile, polyethylene terephthalate resins have a good molding fluidity.

In recent years, resin molded articles made of resin compositions have come to have a small thickness, and resin molded articles formed of a resin composition containing a polycarbonate resin and a polyethylene terephthalate rein need to have an enhanced flame resistance and surface impact strength.

### SUMMARY

According to an aspect of the invention, there is provided a resin composition containing a polycarbonate resin, a polyethylene terephthalate resin, a glycidyl-group-containing polyethylene copolymer, a vinyl acetate-ethylene copolymer, an organic phosphorus flame retardant, and a flame-retardant anti-drip agent, wherein the amounts of the polycarbonate resin and polyethylene terephthalate resin are approximately from 60 mass % to 90 mass % and approximately from 10 mass % to 40 mass % relative to the total amount of the polycarbonate resin and the polyethylene terephthalate resin, respectively, the glycidyl-group-containing polyethylene copolymer contains a glycidyl-group-containing (meth)acrylate unit and an ethylene unit, the glycidyl-group-containing (meth)acrylate unit content in the glycidyl-group-containing polyethylene copolymer is approximately in the range of 2 mass % to 20 mass %, and the glycidyl-group-containing polyethylene copolymer is any one of a polyethylene copolymer having a glass transition temperature of approximately not more than 0° C. and a copolymer in which a polymerizable vinyl monomer has been graft-polymerized with the main chain of a polyethylene copolymer containing a glycidyl-group-containing (meth)acrylate unit and an ethylene unit.

### BRIEF DESCRIPTION OF THE DRAWING

Exemplary embodiments of the present invention will be described in detail based on the following figure, wherein:

The FIGURE is a schematic plan view illustrating a test sample used in a strength test of a louver.

### DETAILED DESCRIPTION

Exemplary embodiments of the invention will now be described. Exemplary embodiments are merely examples of the invention, and the invention is not limited thereto.

### Resin Composition

The resin composition according to a first exemplary embodiment contains a polycarbonate resin, a polyethylene terephthalate resin, a glycidyl-group-containing polyethylene copolymer, a vinyl acetate-ethylene copolymer, an organic phosphorus flame retardant, and a flame-retardant anti-drip agent. In the resin composition, the amounts of the polycarbonate resin and polyethylene terephthalate resin are approximately from 60 mass % to 90 mass % and approximately from 10 mass % to 40 mass % relative to the total amount of the polycarbonate resin and the polyethylene terephthalate resin, respectively, the glycidyl-group-containing polyethylene copolymer contains a glycidyl-group-containing (meth)acrylate unit and an ethylene unit, the glycidyl-group-containing (meth)acrylate unit content in the glycidyl-group-containing polyethylene copolymer is approximately in the range of 2 mass % to 20 mass %, and the glycidyl-group-containing polyethylene copolymer is any one of a polyethylene copolymer having a glass transition temperature of approximately not more than 0° C. and a copolymer in which a polymerizable vinyl monomer has been graft-polymerized with the main chain of a polyethylene copolymer containing a glycidyl-group-containing (meth)acrylate unit and an ethylene unit.

The resin composition of the first exemplary embodiment enables production of a resin molded article having a higher surface impact strength and flame resistance than a product made of a resin composition containing a polycarbonate resin, a polyethylene terephthalate resin, organic phosphorus flame retardant, and a flame-retardant anti-drip agent. The mechanism that brings this effect has been still studied but is presumed to be as follows.

It is contemplated that the vinyl acetate-ethylene copolymer and the glycidyl-group-containing polyethylene copolymer are dissolved to form a second domain in the resin composition of the first exemplary embodiment. Furthermore, it is believed that the polycarbonate resin and polyethylene terephthalate resin dispersed in the resin composition are cross-linked to each other via the second domain. Moreover, it is speculated that the second domain has an enhanced viscosity at room temperature as compared with the case where the second domain is free from the vinyl acetate-ethylene copolymer and that it therefore serves as an elastomer having an enhanced impact-absorbing property. These are believed to contribute to an enhancement in the surface impact strength of a resin molded article made of the resin composition of the first exemplary embodiment.

In the resin composition of the first exemplary embodiment, since the vinyl acetate-ethylene copolymer and the glycidyl-group-containing polyethylene copolymer are dissolved to form a second domain having an excellent impact-absorbing property as described above, a resin molded article to be produced is expected to have a higher surface impact strength than a product made of a resin composition in which the vinyl acetate-ethylene copolymer is not used and in which the polycarbonate resin and the polyethylene terephthalate resin are cross-linked to each other via the glycidyl-group-containing polyethylene copolymer.

The organic phosphorus flame retardant and the flame-retardant anti-drip agent in the resin composition of the first exemplary embodiment contribute to an enhancement in the flame resistance of a molded article; for instance, if the molded article is burned, a combination of these materials with the glycidyl-group-containing polyethylene resin is expected to enable easy formation of a carbonized layer on the surface of the molded article so that the flame resistance of the resin molded article is enhanced.

The components contained in the resin composition of the first exemplary embodiment will now be described.

### Polycarbonate Resin

Examples of the polycarbonate resin include an aromatic polycarbonate, a polyorganosiloxane-containing aromatic polycarbonate, an aliphatic polycarbonate, and an alicyclic polycarbonate. An aromatic polycarbonate resin is suitably used in terms of the surface impact strength of the resin molded article. Examples of the aromatic polycarbonate resin include polycarbonates involving bisphenols A, Z, S, MIBK, AP, and TP; polycarbonates involving biphenyl; and polycarbonates involving hydrogenated bisphenol A.

The polycarbonate resin is produced, for example, through the reaction of dihydric phenol and a carbonate precursor.

Examples of the dihydric phenol include 2,2-bis(4-hydroxyphenyl)propane (bisphenol A), bis(4-hydroxyphenyl) methane, 1,1-bis(4-hydroxyphenyl) ethane, 2,2-bis(4-hydroxy-3,5-dimethylphenyl) propane, bis(4-hydroxyphenyl)cycloalkane, bis(4-hydroxyphenyl)oxide, bis(4-hydroxyphenyl)sulfide, bis(4-hydroxyphenyl)sulfone, bis(4-hydroxyphenyl)sulfoxide, bis(4-hydroxyphenyl)ether, and bis(4-hydroxyphenyl)ketone.

Examples of the carbonate precursor include carbonyl halides, carbonyl esters, and haloformates. Specific examples thereof include phosgene, dihaloformates of a dihydric phenol, diphenyl carbonate, dimethyl carbonate, and diethyl carbonate.

The weight average molecular weight (Mw) of the polycarbonate resin is, for example, approximately in the range of 50000 to 60000. At the weight average molecular weight of the polycarbonate resin approximately in the range of 50000 to 60000, the surface impact strength of a resin molded article may be further enhanced as compared with the case where the weight average molecular weight is out of this range. The number average molecular weight (Mn) of the polycarbonate resin may be, for instance, in the range of 10000 to 30000. At a number average molecular weight of the polycarbonate resin of less than 10000, the fluidity of the resin composition becomes excessive, which may impair the processability of a resin molded article; at a number average molecular weight of the polycarbonate resin of greater than 30000, the fluidity of the resin composition is reduced, which may also impair the processability of a resin molded article.

The weight average molecular weight and the number average molecular weight are measured by gel permeation chromatography (GPC). In the measurement of the molecular weights by GPC, a measuring device to be used is GPC-HLC-8120 manufactured by Tosoh Corporation, a column to be used is TSKgel Super HM-M (15 cm) manufactured by Tosoh Corporation, and a solvent is hexafluoroisopropanol. The weight average molecular weight and the number average molecular weight are calculated using a molecular weight calibration curve obtained from result of the measurement with standard samples of monodisperse polystyrene. The same holds true for the measurement of the weight average molecular weight and number average molecular weight in the following description.

The amount of the polycarbonate resin used in the first exemplary embodiment is not particularly limited provided that it is approximately from 60 mass % to 90 mass % relative to the total amount of the polycarbonate resin and the polyethylene terephthalate resin; for example, it may be in the range of 40 mass % to 80 mass %. In the case where the amount of the aromatic polycarbonate is less than 60 mass % or greater than 90 mass %, the molding fluidity of the resin composition is reduced as compared with the case where the amount is within such a range, which may impair the surface impact strength of the resin molded article.

The concentration of terminal hydroxyl groups in the polycarbonate resin used in the first exemplary embodiment is approximately in the range of 10 μeq/g to 15 μeq/g. The concentration of terminal hydroxyl groups in the polycarbonate resin approximately in the range of 10 μeq/g to 15 μeq/g enables more terminal groups to react with glycidyl groups as compared with the case where the concentration of terminal hydroxyl groups in the polycarbonate resin is less than 10 μeq/g, and thus more cross-linking is expected to be formed between the polycarbonate resin and the polyethylene terephthalate resin. Hence, the surface impact strength of a resin molded article to be produced is expected to be further enhanced. Furthermore, unnecessary reaction with a glycidyl group is suppressed as compared with the case where the concentration of terminal hydroxyl groups in the polycarbonate resin is greater than 15 μeq/g; hence, gelation of the polycarbonate material is believed to be reduced. Such a reduction in gelation of the polycarbonate material inhibits a reduction in the molding fluidity of the resin composition, and the surface impact strength is therefore expected to be further enhanced. The concentration of terminal hydroxyl groups in a virgin (unused) polycarbonate resin is adjusted by a change in the amount of an end-capping agent in a polymerization process. The concentration of terminal hydroxyl groups in a polycarbonate resin collected from the market (hereinafter also referred to as “recycled PC”) depends on usage thereof in the market. Measurement of the concentration of terminal hydroxyl groups will be described in Examples.

The polycarbonate resin used in the first exemplary embodiment may contain a recycled PC resin. In the recycled PC resin, hydrolysis has further proceeded as compared with a polycarbonate resin that has not used in the market yet; hence, the recycled PC resin is likely to be a polycarbonate resin having the concentration of terminal hydroxyl groups approximately from 10 μeq/g to 15 μeq/g. The surface impact strength of a resin molded article is therefore expected to be enhanced.

The recycled PC resin is produced, for example, by collecting the resin molded article of a polycarbonate resin from the market and grinding it with a grinder such as a dry or wet grinder. The amount of the recycled PC resin is, for instance, preferably in the range of 10% to 90%, and more preferably 20% to 80% relative to the total amount of the polycarbonate resins contained in the resin composition. It is believed that the amount of the recycled PC resin from 10% to 90% enables a further enhancement in the impact resistance of a resin molded article as compared with the case where the amount is out of this range.

### Polyethylene Terephthalate Resin

The amount of the polyethylene terephthalate resin is not particularly limited provided that the amount is approximately from 10 mass % to 40 mass % relative to the total amount of the polycarbonate resin and the polyethylene terephthalate resin; for example, it may be from 20 mass % to 30 mass %. In the case where the amount of the polyethylene terephthalate resin is less than 10 mass % or greater than 40 mass %, the surface impact strength of a resin molded article is impaired owing to, for example, a reduction in the molding fluidity of the resin as compared with the case where the amount is within such a range.

The weight average molecular weight of the polyethylene terephthalate resin used in the first exemplary embodiment may be, for example, in the range of 5000 to 100000. The number average molecular weight of the polyethylene terephthalate resin used in the first exemplary embodiment may be, for example, in the range of 5000 to 50000. In the case where the weight average molecular weight of the polyethylene terephthalate resin is less than 5000 and where the number average molecular weight thereof is less than 5000, the fluidity of the resin composition becomes excessive as compared with the case where the molecular weights are within the above-mentioned ranges, which may result in impairing the processability of the resin molded article. In the case where the weight average molecular weight of the polyethylene terephthalate resin is greater than 100000 and where the number average molecular weight thereof is greater than 50000, the fluidity of the resin composition is reduced as compared with the case where the molecular weights are within the above-mentioned ranges, which may result in impairing the processability of the resin molded article.

The acid value of the polyethylene terephthalate resin used in the first exemplary embodiment is approximately in the range of 10 eq/t to 15 eq/t. At the acid value of the polyethylene terephthalate resin approximately in the range of 10 eq/t to 15 eq/t, more terminal groups react with glycidyl groups as compared with the case where the acid value of the polyethylene terephthalate resin is less than 10 eq/t, which enables the polyethylene terephthalate resin to have a larger molecular weight. Thus, the surface impact strength of a resin molded article is expected to be further enhanced. Moreover, unnecessary reaction with glycidyl groups is suppressed as compared with the case where the acid value of the polyethylene terephthalate resin is greater than 15 eq/t; hence, gelation of the polyethylene terephthalate material is expected to be reduced. Such a reduction in gelation of the polyethylene terephthalate material inhibits a reduction in the molding fluidity of the resin composition, and the surface impact strength is therefore expected to be further enhanced. The acid value of the polyethylene terephthalate is adjusted by solid phase polymerization. Measurement of the acid value will be described in Examples.

The polyethylene terephthalate resin used in the first exemplary embodiment may contain a polyethylene terephthalate resin collected from the market (hereinafter also referred to as “recycled PET resin”). In the recycled PET resin, hydrolysis has further proceeded as compared with a PET resin that has not used in the market yet; hence, the recycled PET resin is likely to be a PET resin having an acid value ranging approximately from 10 eq/t to 15 eq/t. It is believed that the surface impact strength of a resin molded article is therefore enhanced.

The recycled PET resin is produced, for example, by collecting the resin molded article of a PET resin from the market and grinding it with a grinder such as a dry or wet grinder. The amount of the recycled PET resin is, for instance, preferably not less than 30%, and more preferably not less than 40% relative to the total amount of aromatic polyester resins contained in the resin composition. In the case where the amount of the recycled PET resin is not less than 30%, a resin molded article may have a reduced tensile elongation at break as compared with the case where the amount is out of the range.

### Glycidyl-Group-Containing Polyethylene Copolymer

The glycidyl-group-containing polyethylene copolymer contains an ethylene unit and a glycidyl-group-containing (meth)acrylate unit. The glycidyl-group-containing (meth)acrylate unit content in the glycidyl-group-containing polyethylene copolymer is approximately from 2 mass % to 20 mass %. The glycidyl-group-containing polyethylene copolymer is a polyethylene copolymer having a glass transition temperature of approximately not more than 0° C. or a copolymer in which a polymerizable vinyl monomer has been graft-polymerized with the main chain of a polyethylene copolymer containing an ethylene unit and a glycidyl-group-containing (meth)acrylate unit. Examples of the glycidyl-group-containing (meth)acrylate unit include constitutional units derived from monomers such as glycidyl(meth)acrylate, a vinyl glycidyl ether, a (meth)acryl glycidyl ether, a 2-methyl propenyl glycidyl ether, a styrene-p-glycidyl ether, glycidyl cinnamate, an itaconic acid glycidyl ester, and N-[4-(2,3-epoxypropoxy)-3,5-dimethylbenzyl]methacrylamide. The term “(meth)acryl” refers to acryl or methacryl.

Use of the glycidyl-group-containing polyethylene copolymer in the first exemplary embodiment is expected to enhance the surface impact strength of a resin molded article to be produced as compared with use of a glycidyl-group-containing polyethylene copolymer which contains an ethylene unit and a glycidyl-group-containing (meth)acrylate unit and in which the glycidyl-group-containing (meth)acrylate unit content is less than 2 mass % or greater than 20 mass %. In the case where the glycidyl-group-containing (meth)acrylate unit content in the glycidyl-group-containing polyethylene copolymer is less than 2 mass %, the molecular weight of the polyethylene terephthalate resin is not enhanced as compared with the case where the content is within the above-mentioned range. In the case where the glycidyl-group-containing (meth)acrylate unit content in the glycidyl-group-containing polyethylene copolymer is greater than 20 mass %, it is speculated that the fluidity of the resin composition is impaired as compared with the case where the content is within the above-mentioned range, which results in a reduction in the processability of a resin molded article. In the case where the glass transition temperature is greater than 0° C., the elasticity of a resin molded article to be produced is expected to be reduced as compared with the case where the glass transition temperature is about not more than 0° C.

The glass transition temperature of the glycidyl-group-containing polyethylene copolymer refers to a glass transition temperature measured as follows. Heat capacity is measured with a differential calorimeter (differential scanning calorimeter DSC-60 manufactured by SHIMADZU CORPORATION) at a rate of temperature increase of 10° C. per minute to define the spectrum of the heat capacity, and the intermediate value between the values of two shoulders (Tgm) obtained by a tangent line method from peaks derived from glass transition is defined as glass transition temperature.

An example of a technique for preparing the glycidyl-group-containing polyethylene copolymer is living polymerization of a monomer that serves as the ethylene unit with a monomer that serves as the glycidyl-group-containing (meth)acrylate unit. Examples of such living polymerization include anionic polymerization involving use of an organoalkali metal compound as a polymerization initiator in the presence of a mineral acid salt such as a salt of an alkali metal or alkali earth metal, anionic polymerization involving use of an organoalkali metal compound as a polymerization initiator in the presence of an organoaluminum compound, polymerization involving use of an organic rare earth metal complex as a polymerization initiator, and a radical polymerization involving use of an α-halogenated ester compound as an initiator in the presence of a copper compound.

An example of a technique for preparing the copolymer in which a polymerizable vinyl monomer has been graft-polymerized with the main chain of the polyethylene copolymer is a single-step or multistep polymerization by radical polymerization, in which the polymerizable vinyl monomer is added to the polyethylene copolymer.

Examples of the polymerizable vinyl monomer include an ester vinyl monomer unit, an aromatic vinyl monomer unit, and a vinyl cyanide monomer unit. Examples of the ester vinyl monomer unit include methyl (meth)acrylate, ethyl (meth)acrylate, butyl (meth)acrylate, isobutyl (meth)acrylate, and 2-ethylhexyl (meth)acrylate. Examples of the aromatic vinyl monomer include styrene and vinylnaphthalene. Examples of the vinyl cyanide monomer include acrylonitrile, α-chloroacrylonitrile, and methacrylonitrile.

The weight average molecular weight of the glycidyl-group-containing polyethylene copolymer may be, for example, from 3000 to 100000. In the case where the weight average molecular weight of the glycidyl-group-containing polyethylene copolymer is less than 3000, impact resistance may be reduced as compared with the case where it is within the above-mentioned range; in the case where the weight average molecular weight of the glycidyl-group-containing polyethylene copolymer is greater than 100000, the dispersibility thereof in the resin composition may be reduced as compared with the case where it is within the above-mentioned range.

The amount of the glycidyl-group-containing polyethylene copolymer is preferably approximately in the range of 4 mass % to 10 mass %, and more preferably approximately 6 mass % to 8 mass % relative to 100 parts by mass of the total amount of the polycarbonate resin and the polyethylene terephthalate resin. The amount of the glycidyl-group-containing polyethylene copolymer approximately in the range of 4 mass % to 10 mass % is believed to enable an enhancement in the surface impact strength of a resin molded article to be produced as compared with the case where the amount is less than 4 mass % or greater than 10 mass %.

### Vinyl Acetate-Ethylene Copolymer

The vinyl acetate-ethylene copolymer is not particularly limited provided that it is a copolymer containing an ethylene unit and a vinyl acetate unit; in the vinyl acetate-ethylene copolymer, the vinyl acetate unit content is preferably approximately in the range of 15 mass % to 25 mass %, more preferably approximately 13 mass % to 22 mass %. In the case where the vinyl acetate unit content in the vinyl acetate copolymer is approximately from 15 mass % to 25 mass %, a resin molded article to be produce is expected to have an enhanced Charpy impact strength and tensile elongation at break owing to, for example, an improvement in the dispersibility of the polycarbonate resin and polyethylene terephthalate resin or an increase in the viscosity of the domain as compared with the case where the content is out of the range.

An example of a technique for preparing the vinyl acetate-ethylene copolymer is living polymerization of a monomer that serves as the ethylene unit with a monomer that serves as the vinyl acetate unit. Examples of such living polymerization include anionic polymerization involving use of an organoalkali metal compound as a polymerization initiator in the presence of a mineral acid salt such as a salt of an alkali metal or alkali earth metal, anionic polymerization involving use of an organoalkali metal compound as a polymerization initiator in the presence of an organoaluminum compound, polymerization involving use of an organic earth metal complex as a polymerization initiator, and a radical polymerization involving use of an α-halogenated ester compound as an initiator in the presence of a copper compound.

The vinyl acetate-ethylene copolymer, which contains the ethylene unit and the vinyl acetate unit, may optionally contain a polymerizable vinyl monomer that can be copolymerized with the ethylene unit or the vinyl acetate unit. Examples of the vinyl monomer include an ester vinyl monomer unit, an aromatic vinyl monomer unit, and a vinyl cyanide monomer unit. Examples of the ester vinyl monomer unit include methyl (meth)acrylate, ethyl (meth)acrylate, butyl (meth)acrylate, isobutyl (meth)acrylate, and 2-ethylhexyl (meth)acrylate. Examples of the aromatic vinyl monomer include styrene and vinylnaphthalene. Examples of the vinyl cyanide monomer include acrylonitrile, α-chloroacrylonitrile, and methacrylonitrile.

The weight average molecular weight of the vinyl acetate-ethylene copolymer may be, for example, in the range of 3000 to 100000. In the case where the weight average molecular weight of the vinyl acetate-ethylene copolymer is less than 3000, impact resistance may be reduced as compared with the case where it is within the above-mentioned range; in the case where the weight average molecular weight of the vinyl acetate-ethylene copolymer is greater than 100000, the dispersibility thereof in the resin composition may be reduced as compared with the case where it is within the above-mentioned range.

The amount of the vinyl acetate-ethylene copolymer is preferably in the range of 1 mass % to 5 mass %, and more preferably 1 mass % to 4 mass % relative to 100 parts by mass of the total amount of the polycarbonate resin and the polyethylene terephthalate resin. The amount of the vinyl acetate-ethylene copolymer in the range of 1 mass % to 5 mass % is believed to further enhance the surface impact strength of a resin molded article to be produced as compared with the case where the amount is less than 1 mass % or greater than 5 mass %.

### Organic Phosphorus Flame Retardant

Examples of the organic phosphorus flame retardant include aromatic phosphate, aromatic condensed phosphate, phosphinate, and polyphosphate having a triazine skeleton. The organic phosphorus flame retardant to be used may be synthetized or commercially obtained. Examples of commercially available products of the organic phosphorus flame retardant include CR-741 manufactured by DAIHACHI CHEMICAL INDUSTRY CO., LTD., AP422 manufactured by Clariant, and Nova Excel 140 manufactured by RIN KAGAKU KOGYO Co., Ltd.

### Flame-Retardant Anti-Drip Agent

Any flame-retardant anti-drip agent can be used provided that it can reduce dropping (drip) of a resin from a resin molded article that has been burned; examples thereof include fluororesins such as polytetrafluoroethylene, polyvinylidene fluoride, and polyhexafluoropropylene.

### Other Components

The resin composition of the first exemplary embodiment may contain other components provided that the surface impact strength and flame resistance of a resin molded article to be produced are not impaired. Examples of such other components include a hydrolysis inhibitor, an antioxidant, and a filler.

Examples of the hydrolysis inhibitor include a carbodiimide compound and an oxazoline compound. Examples of the carbodiimide compound include dicyclohexyl carbodiimide, diisopropyl carbodiimide, dimethyl carbodiimide, diisobutyl carbodiimide, dioctyl carbodiimide, diphenyl carbodiimide, and naphthyl carbodiimide.

Examples of the antioxidant include a phenol antioxidant, an amine antioxidant, a phosphorus antioxidant, a sulfur antioxidant, a hydroquinone antioxidant, and a quinoline antioxidant.

Examples of the filler include clay such as kaolin, bentonite, kibushi clay, and gairome clay; talc; mica; and montmorillonite.

### Resin Molded Article

The resin molded article of a second exemplary embodiment contains the resin composition of the first exemplary embodiment. The resin molded article of the second exemplary embodiment is produced through, for instance, molding the resin composition of the first exemplary embodiment by a technique such as injection molding, extrusion molding, blow molding, or hot press molding. In the second exemplary embodiment, the resin molded article can be produced by injection-molding the resin composition of the first exemplary embodiment in view of dispersibility of the components contained in the resin molded article.

The injection molding may be, for instance, performed with a commercially available apparatus such as NEX 150 manufactured by NISSEI PLASTIC INDUSTRIAL CO., LTD.; NEX 70000 manufactured by NISSEI PLASTIC INDUSTRIAL CO., LTD.; or NEX 500 manufactured by TOSHIBA MACHINE CO., LTD. In use of such apparatuses, the cylinder temperature may be in the range of 170° C. to 280° C. In addition, the mold temperature may be in the range of 30° C. to 120° C. in view of, for example, productivity.

The resin molded article of the second exemplary embodiment is appropriately used in applications such as electronic and electrical equipment, household electric appliances, containers, and interior materials for automobiles. More specifically, the resin molded article is used in the housings and various parts of household electric appliances and electronic and electrical equipment; wrapping films; storage cases of CD-ROMs, DVDs, and other products; tableware; food trays; bottles for beverage; and medicine-wrapping materials. Among these, it is suitably used in the parts of electronic and electrical equipment. In particular, the parts of electronic and electrical equipment need to have a high impact resistance and flame resistance. The resin molded article of the second exemplary embodiment, which is made of the above-mentioned resin composition, has a higher surface impact strength and flame resistance than a resin molded article made of a resin composition containing a polycarbonate resin, a polyethylene terephthalate resin, an organic phosphorus flame retardant, and a flame-retardant anti-drip agent.

### EXAMPLES

Examples and Comparative Examples will now be described to explain the invention further in detail, but the invention is not limited to such Examples.

### Polycarbonate Resin

A polycarbonate resin (hereinafter referred to as “PC resin”) used in Examples and Comparative Examples is a recycled PC resin derived from bottles for beverage.

### Polyethylene Terephthalate Resin

A polyethylene terephthalate resin (hereinafter referred to as “PET resin”) used in Examples and Comparative Examples is a recycled PET resin derived from bottles made of PET for beverage.

Table 1 shows the weight average molecular weight (Mw), number average molecular weight (Mn), and Mw/Mn of the PC resin; the concentration of terminal hydroxyl groups therein; and the acid value of the PET resin.

### Measurement of Concentration of Terminal Hydroxyl Groups

The concentration of terminal hydroxyl groups (μeq/g) in the PC resin refers to the number of the phenolic terminal hydroxyl groups that are present in 1 g of the PC resin. The concentration is measured by colorimetry based on a titanium tetrachloride/acetic acid method [see Macromol. Chem. 88215 (1965)].

### Measurement of Acid Value

The acid value of the PET resin is measured as follows.

### Preparation of Sample

A test piece is ground, vacuum-dried at 70° C. for 24 hours, and then weighed in a balance into 0.20±0.0005 g. This weight is defined as W(g). The weighed test piece and 10 ml of benzyl alcohol are put into a test tube, the test tube is immersed in an oil bath at 205° C., and then the content is dissolved by being stirred with a glass rod. The dissolution of the content is carried out over different lengths of time of three minutes, five minutes, and seven minutes to produce samples A, B, and C, respectively. Then, another test tube is prepared, only benzyl alcohol is put thereinto, and the same procedure is carried out. The dissolution is performed over different lengths of time of three minutes, five minutes, and seven minutes to produce samples a, b, and c, respectively.

### Titration

The samples produced in the manner described above are titrated with 0.04 mol/l of a potassium hydroxide solution (solution in ethanol) of which the factor has been known. Phenol red is used as an indicator, and the titer (ml) of the potassium hydroxide solution is determined at the end point at which the color of the sample turns from yellowish green to pink. The titers in the samples A, B, and C are defined as XA, XB, and XC (ml), respectively; and the titers in the samples a, b, and c are defined as Xa, Xb, and Xc (ml), respectively.

### Calculation of Acid Value

From the titers XA, XB, and XC corresponding to the individual dissolution times, a titer V(ml) at a dissolution time of zero minute is obtained by a least squares method. Likewise, a titer V0(ml) is obtained from the titers Xa, Xb, and Xc. Then, an acid value is calculated from the following equation.

Acid Value (eq/t)=[(V−V0)×0.04×NF×1000]/W

NF: Factor of 0.04 mol/l of potassium hydroxide solution
W: Weight of sample (g)

TABLE 1

| | | | | | Concentration |
|---|---|---|---|---|---|
| | | | | | of terminal |
| | | | | | hydroxyl |
| | | | | | groups |
| Polycarbonate resin | | Mw | Mn | Mw/Mn | (μeq/g) |
| PC | Derived from | 58,500 | 19,400 | 3.02 | 12 |
| resin | beverage bottles | | | | |

| | | Acid value |
|---|---|---|
| Polyethylene terephthalate resin | | (eq/t) |
| PET resin | Derived from PET beverage | 15 |
| | bottles | |

### Glycidyl-Group-Containing Polyethylene Copolymer C-1

A glycidyl-group-containing polyethylene copolymer C-1 is AX8900 (manufactured by Arkema S.A.) which is a copolymer of glycidyl methacrylate/ethylene/methyl acrylate. The composition ratio of glycidyl methacrylate/ethylene/methyl acrylate is 8/68/24 (mass %). The glass transition temperature (Tg) of the glycidyl-group-containing polyethylene copolymer C-1 is −33° C.

### Glycidyl-Group-Containing Polyethylene Copolymer C-2

A glycidyl-group-containing polyethylene copolymer C-2 is BONDFAST 7L (manufactured by Sumitomo Chemical Company, Limited) which is a copolymer of glycidyl methacrylate/ethylene/methyl acrylate. The composition ratio of glycidyl methacrylate/ethylene/methyl acrylate is 3/70/27 (mass %). The glass transition temperature (Tg) of the glycidyl-group-containing polyethylene copolymer C-2 is −33° C.

### Glycidyl-Group-Containing Polyethylene Copolymer C-3

A glycidyl-group-containing polyethylene copolymer C-3 is CG5001 (manufactured by Sumitomo Chemical Company, Limited) which is a copolymer of glycidyl methacrylate/ethylene. The composition ratio of glycidyl methacrylate/ethylene is 19/81 (mass %). The glass transition temperature (Tg) of the glycidyl-group-containing polyethylene copolymer C-3 is −38° C.

### Glycidyl-Group-Containing Polyethylene Copolymer C-4

A glycidyl-group-containing polyethylene copolymer C-4 is MODIPER A4300 (manufactured by NOF CORPORATION) which is a copolymer in which butyl acrylate and methyl methacrylate as vinyl monomers have been graft-polymerized with the main chain of a copolymer of glycidyl methacrylate/ethylene. The composition ratio of glycidyl methacrylate/ethylene/butyl acrylate/methyl methacrylate is 9/61/21/9 (mass %). The glass transition temperature (Tg) of the copolymer of glycidyl methacrylate/ethylene is −45° C.

### Glycidyl-Group-Containing Polyethylene Copolymer C-5

To 94 parts by mass of polyethylene (trade name: Nipolon Z 1P53A, manufactured by Tosoh Corporation), 6 parts by mass of glycidyl methacrylate and 0.5 parts by mass of dialkyl peroxide (trade name: PERHEXA 25B, manufactured by NOF CORPORATION) are added; then, these materials are evenly mixed with each other in a Henschel mixer. The mixture is subsequently extruded with a twin-screw extruder (trade name: TEM-35, manufactured by TOSHIBA MACHINE CO., LTD.) at a cylinder temperature of 220° C. to produce a copolymer of ethylene/glycidyl methacrylate [composition ratio of ethylene/glycidyl methacrylate is 94/6 (mass %)]. The glass transition temperature (Tg) of the copolymer of ethylene/glycidyl methacrylate is −51° C. This copolymer is defined as a glycidyl-group-containing polyethylene copolymer C-5.

Table 2 shows the constitution of each of the glycidyl-group-containing polyethylene copolymers C-1 to C-5.

TABLE 2

| | | | Glycidyl-group-containing | | | | |
|---|---|---|---|---|---|---|---|
| | | | polyethylene copolymer | | | | |
| | | | C-1 | C-2 | C-3 | C-4 | C-5 |
| Constituents | Glycidyl-group-containing | Glycidyl methacrylate | 8 | 3 | 19 | 9 | 6 |
| of main chain | (meth)acrylate unit | | | | | | |
| | Others | Ethylene | 68 | 70 | 81 | 61 | 94 |
| | | Methyl methacrylate | | | | | |
| | | Methyl acrylate | 24 | 27 | | | |
| Constituents | | Butyl acrylate | | | | 21 | |
| of side chain | | Methyl methacrylate | | | | 9 | |
| | | Tg (° C.) of main chain | −33 | −33 | −38 | −45 | −51 |

### Vinyl Acetate-ethylene Copolymer D-1

To 85 parts by mass of polyethylene (trade name: Nipolon Z 1P53A, manufactured by Tosoh Corporation), 15 parts by mass of vinyl acetate and 0.5 parts by mass of dialkyl peroxide (trade name: PERHEXA 25B, manufactured by NOF CORPORATION) are added; then, these materials are evenly mixed with each other in a Henschel mixer. The mixture is subsequently extruded with a twin-screw extruder (trade name: TEM-35, manufactured by TOSHIBA MACHINE CO., LTD.) at a cylinder temperature of 220° C. to produce a vinyl acetate-ethylene copolymer [composition ratio of ethylene/vinyl acetate is 85/15 (mass %)]. The glass transition temperature (Tg) of the vinyl acetate-ethylene copolymer is −37° C. This copolymer is defined as a vinyl acetate-ethylene copolymer D-1.

### Vinyl Acetate-Ethylene Copolymer D-2

A vinyl acetate-ethylene copolymer D-2 is EVATANE 20-20 manufactured by Arkema S.A. The composition ratio of ethylene/vinyl acetate is 80/20 (mass %). The glass transition temperature (Tg) of the vinyl acetate-ethylene copolymer D-2 is −36° C.

### Vinyl Acetate-Ethylene Copolymer D-3

To 75 parts by mass of polyethylene (trade name: Nipolon Z 1P53A, manufactured by Tosoh Corporation), 25 parts by mass of vinyl acetate and 0.5 parts by mass of dialkyl peroxide (trade name: PERHEXA 25B, manufactured by NOF CORPORATION) are added; then, these materials are evenly mixed with each other in a Henschel mixer. The mixture is subsequently extruded with a twin-screw extruder (trade name: TEM-35, manufactured by TOSHIBA MACHINE CO., LTD.) at a cylinder temperature of 220° C. to produce a vinyl acetate-ethylene copolymer [composition ratio of ethylene/vinyl acetate is 75/25 (mass %)]. The glass transition temperature (Tg) of the vinyl acetate-ethylene copolymer is −35° C. This copolymer is defined as a vinyl acetate-ethylene copolymer D-3.

### Vinyl Acetate-Ethylene Copolymer D-4

To 86 parts by mass of polyethylene (trade name: Nipolon Z 1P53A, manufactured by Tosoh Corporation), 14 parts by mass of vinyl acetate and 0.5 parts by mass of dialkyl peroxide (trade name: PERHEXA 25B, manufactured by NOF CORPORATION) are added; then, these materials are evenly mixed with each other in a Henschel mixer. The mixture is subsequently extruded with a twin-screw extruder (trade name: TEM-35, manufactured by TOSHIBA MACHINE CO., LTD.) at a cylinder temperature of 220° C. to produce a vinyl acetate-ethylene copolymer [composition ratio of ethylene/vinyl acetate is 86/14 (mass %)]. The glass transition temperature (Tg) of the vinyl acetate-ethylene copolymer is −39° C. This copolymer is defined as a vinyl acetate-ethylene copolymer D-4.

### Vinyl Acetate-Ethylene Copolymer D-5

To 74 parts by mass of polyethylene (trade name: Nipolon Z 1P53A, manufactured by Tosoh Corporation), 26 parts by mass of vinyl acetate and 0.5 parts by mass of dialkyl peroxide (trade name: PERHEXA 25B, manufactured by NOF CORPORATION) are added; then, these materials are evenly mixed with each other in a Henschel mixer. The mixture is subsequently extruded with a twin-screw extruder (trade name: TEM-35, manufactured by TOSHIBA MACHINE CO., LTD.) at a cylinder temperature of 220° C. to produce a vinyl acetate-ethylene copolymer [composition ratio of ethylene/vinyl acetate is 74/26 (mass %)]. The glass transition temperature (Tg) of the vinyl acetate-ethylene copolymer is −33° C. This copolymer is defined as a vinyl acetate-ethylene copolymer D-5.

Table 3 shows the constitution of each of the vinyl acetate-ethylene copolymers D-1 to D-5.

TABLE 3

| | | Vinyl acetate-ethylene copolymer | | | | |
|---|---|---|---|---|---|---|
| | | D-1 | D-2 | D-3 | D-4 | D-5 |
| Constituents | Vinyl acetate | 15 | 20 | 25 | 14 | 26 |
| | Ethylene | 85 | 80 | 75 | 86 | 74 |
| | Tg (° C.) | −37 | −36 | −35 | −39 | −33 |

### Example 1

In accordance with the constitution shown in Table 4 (all on a mass basis), 70 parts by mass of the PC resin, 30 parts by mass of the PET resin, 4 parts by mass of the glycidyl-group-containing polyethylene copolymer C-1, 1 part by mass of the vinyl acetate-ethylene copolymer D-1, 15 parts by mass of a flame retardant of aromatic condensed phosphate (trade name: CR-741, phosphorus content: 9%, manufactured by DAIHACHI CHEMICAL INDUSTRY CO., LTD.), 1 part by mass of a flame-retardant anti-drip agent (trade name: A-3800, polytetrafluoroethylene content: 50%, manufactured by MITSUBISHI RAYON CO., LTD.), and 0.2 part by mass of an antioxidant (phenol antioxidant, trade name: Irganox 1076, manufactured by BASF SE) are mixed with each other in a tumbler. Then, the mixture is melt-kneaded and extruded with a twin-screw extruder having a vent (TEX-30α manufactured by The Japan Steel Works, LTD.) at a cylinder temperature and die temperature of 260° C., a screw-rotating rate of 240 rpm, the degree of vent absorption of 100 Mpa, and an ejection rate of 10 kg/h. The resin ejected from the twin-screw extruder is cut into pellets.

The pellets of the resin composition are dried with a hot-air dryer at 90° C. for 4 hours and then injection-molded with an injection molding machine (trade name NEX500, manufactured by TOSHIBA MACHINE CO., LTD.) at a cylinder temperature of 260° C. and a mold temperature of 60° C., thereby yielding a predetermined resin molded article (evaluation specimen).

### Example 2

A predetermined resin molded article (evaluation specimen) is produced as in Example 1 except that the vinyl acetate-ethylene copolymer D-2 is used in place of the vinyl acetate-ethylene copolymer D-1.

### Example 3

A predetermined resin molded article (evaluation specimen) is produced as in Example 1 except that the vinyl acetate-ethylene copolymer D-3 is used in place of the vinyl acetate-ethylene copolymer D-1.

### Example 4

A predetermined resin molded article (evaluation specimen) is produced as in Example 1 except that the vinyl acetate-ethylene copolymer D-4 is used in place of the vinyl acetate-ethylene copolymer D-1.

### Example 5

A predetermined resin molded article (evaluation specimen) is produced as in Example 1 except that the vinyl acetate-ethylene copolymer D-5 is used in place of the vinyl acetate-ethylene copolymer D-1.

### Example 6

A predetermined resin molded article (evaluation specimen) is produced as in Example 1 except that the amount of the vinyl acetate-ethylene copolymer D-1 is changed from 1 part by mass to 2 parts by mass.

### Example 7

A predetermined resin molded article (evaluation specimen) is produced as in Example 1 except that the amount of the vinyl acetate-ethylene copolymer D-1 is changed from 1 part by mass to 4 parts by mass.

### Example 8

A predetermined resin molded article (evaluation specimen) is produced as in Example 1 except that the amount of the vinyl acetate-ethylene copolymer D-1 is changed from 1 part by mass to 5 parts by mass.

### Comparative Example 1

A predetermined resin molded article (evaluation specimen) is produced as in Example 1 except that the vinyl acetate-ethylene copolymer D-1 is not used.

### Comparative Example 2

A predetermined resin molded article (evaluation specimen) is produced as in Example 1 except that the glycidyl-group-containing polyethylene copolymer C-4 replaced the glycidyl-group-containing polyethylene copolymer C-1 and that the vinyl acetate-ethylene copolymer D-1 is not used.

### Comparative Example 3

A predetermined resin molded article (evaluation specimen) is produced as in Example 1 except that the glycidyl-group-containing polyethylene copolymer C-1 is not used and that the amount of the vinyl acetate-ethylene copolymer D-1 is changed from 1 part by mass to 4 parts by mass.

### Comparative Example 4

A predetermined resin molded article (evaluation specimen) is produced as in Example 1 except that the glycidyl-group-containing polyethylene copolymer C-1 and the vinyl acetate-ethylene copolymer D-1 are not used.

### Test and Evaluation

The evaluation specimens are subjected to the following tests and evaluations. Table 4 shows the constitution (all on a mass basis) of each of the resin compositions of Examples 1 to 8 and Comparative Examples 1 to 4 and results of the tests.

### Test of Flame Resistance

In accordance with UL-94, a UL-V test is performed with UL specimens for a V test (thickness: 0.8 mm and 1.5 mm), which are defined in UL-94, to measure the degree of the flame resistance of the specimens. The degree of the flame resistance in accordance with UL-94 are not-V, V-2, V-1, V-0, and 5 VB in an ascending order of flame resistance.

### Test of Heat Resistance

In a state in which a load (1.8 MPa) defined in the test method of ASTM D648 is applied to the evaluation specimens, the temperature of the evaluation specimens is increased to determine a temperature at which the degree of the deflection thereof reaches a predetermined level (deflection temperature under load: DTUL). This temperature is defined as a thermally resistant temperature and evaluated.

### Tensile Strength and Tensile Elongation at Break

The evaluation specimens are subjected to measurement of tensile strength and tensile elongation at break in accordance with JIS K-7113. A molded article to be used is a test specimen of JIS 1 (thickness: 4 mm) that has been produced by injection molding. The larger the tensile strength is, the more excellent the tensile strength is; the larger the tensile elongation at break is, the more excellent the tensile elongation at break is.

### Test of Impact Resistance

Charpy impact strength (unit: kJ/m²) in the MD direction is measured in accordance with ISO-179 by using a specimen, which has been prepared by notching an ISO multipurpose dumbbell test specimen, with a digital impact tester (DG-5 manufactured by Toyo Seiki Seisaku-sho, Ltd.) at a lifting angle of 150°, 2.0 J of a hammer used, and a measurement number of n=10. The larger the Charpy impact strength is, the more excellent impact resistance is.

### Test of Surface Impact Strength

A flat plate having a size of 60 mm×60 mm and thickness of 2 mm is formed by injection molding, and the center of the flat plate is cut to form a square hole of 10 mm×10 mm, thereby producing a test sample. A steel ball having a diameter of 50 mm and a weight of 500 g is dropped from a height ranging from 0.7 to 2 m to the center of the test sample. The surface impact strength thereof is evaluated on the basis of the following criteria. This test of surface impact strength is carried out three times for each of different heights. The result “A” in the dropping of the steel ball from a height of 1.3 m is practically suitable.

A: No damage is caused around square hole of test sample
B: One to three cracks are caused around square hole of test sample
C: Test sample is broken into multiple pieces

### Test of Strength of Louver (Opening)

A test sample 1 having a grid-like louver 10 (opening) as illustrated in the FIGURE is produced with an injection molding machine. A steel ball having a diameter of 50 mm and a weight of 500 g is dropped from a height of 1.3 m to the center of the test sample 1 illustrated in the FIGURE, and the strength of the louver is evaluated on the basis of the following criteria. This test of the strength of louver is carried out three times. The result “A” in the dropping of the steel ball from a height of 1.3 m is practically suitable.

A: No damage is caused in test sample or only minor crack of not more than 1 mm in thickness direction is caused
B: One or two fractured parts are generated around louver
C: Three or more fractured parts are generated around louver

TABLE 4

| | | Example | Example | Example | Example | Example | Example | Example |
|---|---|---|---|---|---|---|---|---|
| | Constitution | 1 | 2 | 3 | 4 | 5 | 6 | 7 |
| Resin | PC resin | 70 | 70 | 70 | 70 | 70 | 70 | 70 |
| composition | PET resin | 30 | 30 | 30 | 30 | 30 | 30 | 30 |
| | Glycidyl-group-containing | 4 | 4 | 4 | 4 | 4 | 4 | 4 |
| | polyethylene copolymer C-1 | | | | | | | |
| | Glycidyl-group-containing | | | | | | | |
| | polyethylene copolymer C-5 | | | | | | | |
| | Vinyl acetate-ethylene | 1 | | | | | 2 | 4 |
| | copolymer D-1 | | | | | | | |
| | Vinyl acetate-ethylene | | 1 | | | | | |
| | copolymer D-2 | | | | | | | |
| | Vinyl acetate-ethylene | | | 1 | | | | |
| | copolymer D-3 | | | | | | | |
| | Vinyl acetate-ethylene | | | | 1 | | | |
| | copolymer D-4 | | | | | | | |
| | Vinyl acetate-ethylene | | | | | 1 | | |
| | copolymer D-5 | | | | | | | |
| | Flame retardant of aromatic | 15 | 15 | 15 | 15 | 15 | 15 | 15 |
| | condensed phosphate | | | | | | | |
| | Flame-retardant anti-drip agent | 1.0 | 1.0 | 1.0 | 1.0 | 1.0 | 1.0 | 1.0 |
| | Antioxidant | 0.2 | 0.2 | 0.2 | 0.2 | 0.2 | 0.2 | 0.2 |
| Results of | | | | | | | | |
| evaluations | | | | | | | | |
| Flame | UL94 Flame resistance | V-0 | V-0 | V-0 | V-0 | V-0 | V-0 | V-0 |
| resistance | (Thickness: 0.8 mm) | | | | | | | |
| | UL94 Flame resistance | 5VB | 5VB | 5VB | 5VB | 5VB | 5VB | 5VB |
| | (Thickness: 1.5 mm) | | | | | | | |
| Heat | DTUL (1.8 MPa) | 71.8 | 72.4 | 72.1 | 71.8 | 71.4 | 71.5 | 71.4 |
| resistance | | | | | | | | |
| Mechanical | Tensile strength (MPa) | 62 | 63 | 62 | 61 | 61 | 63 | 62 |
| properties | Tensile elongation at break (%) | 75 | 85 | 62 | 52 | 36 | 63 | 28 |
| | Charpy impact strength (kJ/m²) | 18 | 20 | 17 | 15 | 14 | 18 | 24 |
| Surface | Drop height: 0.7 m | AAA | AAA | AAA | AAA | AAA | AAA | AAA |
| impact | Drop height: 1.0 m | AAA | AAA | AAA | AAA | AAA | AAA | AAA |
| strength | Drop height: 1.3 m | AAA | AAA | AAA | AAA | AAA | AAA | AAA |
| | Drop height: 1.6 m | AAA | AAA | AAA | AAA | AAA | AAA | AAA |
| | Drop height: 2.0 m | AAB | AAA | AAB | AAB | AAB | AAB | AAA |
| Strength of | Drop height: 1.3 m | AAA | AAA | AAA | AAA | AAA | AAA | AAA |
| louver | Drop height: 1.6 m | AAA | AAA | AAB | AAB | ABB | AAA | AAA |
| | Drop height: 2.0 m | ABC | ABB | BCC | BCC | CCC | AAB | AAA |

| | | Example | Comparative | Comparative | Comparative | Comparative |
|---|---|---|---|---|---|---|
| | Constitution | 8 | Example 1 | Example 2 | Example 3 | Example 4 |
| Resin | PC resin | 70 | 70 | 70 | 70 | 70 |
| composition | PET resin | 30 | 30 | 30 | 30 | 30 |
| | Glycidyl-group-containing | 4 | 4 | | | |
| | polyethylene copolymer C-1 | | | | | |
| | Glycidyl-group-containing | | | 4 | | |
| | polyethylene copolymer C-5 | | | | | |
| | Vinyl acetate-ethylene | 5 | | | 4 | |
| | copolymer D-1 | | | | | |
| | Vinyl acetate-ethylene | | | | | |
| | copolymer D-2 | | | | | |
| | Vinyl acetate-ethylene | | | | | |
| | copolymer D-3 | | | | | |
| | Vinyl acetate-ethylene | | | | | |
| | copolymer D-4 | | | | | |
| | Vinyl acetate-ethylene | | | | | |
| | copolymer D-5 | | | | | |
| | Flame retardant of aromatic | 15 | 15 | 15 | 15 | 15 |
| | condensed phosphate | | | | | |
| | Flame-retardant anti-drip agent | 1.0 | 1.0 | 1.0 | 1.0 | 1.0 |
| | Antioxidant | 0.2 | 0.2 | 0.2 | 0.2 | 0.2 |
| Results of | | | | | | |
| evaluations | | | | | | |
| Flame | UL94 Flame resistance | V-1 | V-0 | V-0 | not-V | not-V |
| resistance | (Thickness: 0.8 mm) | | | | | |
| | UL94 Flame resistance | V-0 | 5VB | 5VB | not-V | V-2 |
| | (Thickness: 1.5 mm) | | | | | |
| Heat | DTUL (1.8 MPa) | 71.0 | 72.7 | 72.0 | 68.2 | 69.8 |
| resistance | | | | | | |
| Mechanical | Tensile strength (MPa) | 62 | 62 | 62 | 56 | 56 |
| properties | Tensile elongation at break (%) | 15 | 110 | 92 | 4 | 3 |
| | Charpy impact strength (kJ/m²) | 23 | 14 | 16 | 1 | 1 |
| Surface | Drop height: 0.7 m | AAA | AAA | AAA | CCC | CCC |
| impact | Drop height: 1.0 m | AAA | AAA | AAA | CCC | CCC |
| strength | Drop height: 1.3 m | AAA | AAA | AAA | CCC | CCC |
| | Drop height: 1.6 m | AAB | AAB | AAB | CCC | CCC |
| | Drop height: 2.0 m | AAB | BBB | ABB | CCC | CCC |
| Strength of | Drop height: 1.3 m | AAA | AAA | AAA | CCC | CCC |
| louver | Drop height: 1.6 m | AAA | BBC | ABB | CCC | CCC |
| | Drop height: 2.0 m | AAB | CCC | CCC | CCC | CCC |

As is clear from Table 4, each of the resin molded articles of Examples 1 to 8, which has been formed of a resin composition containing a PC resin, a PET resin, a glycidyl-group-containing polyethylene copolymer, a vinyl acetate-ethylene copolymer, an organic phosphorus flame retardant, and a flame-retardant anti-drip agent, has a higher surface impact strength and flame resistance than the resin molded article of Comparative Example 4, which has been formed of a resin composition containing a PC resin, a PET resin, an organic phosphorus flame retardant, and a flame-retardant anti-drip agent. Furthermore, these resin molded articles of Examples 1 to 8 have a higher surface impact strength than the resin molded articles of Comparative Examples 1 and 2, which have been formed of the resin compositions each containing a PC resin, a PET resin, a glycidyl-group-containing polyethylene copolymer, an organic phosphorus flame retardant, and a flame-retardant anti-drip agent, and the resin molded article of Comparative Example 3, which has been formed of the resin composition containing a PC resin, a PET resin, a vinyl acetate-ethylene copolymer, an organic phosphorus flame retardant, and a flame-retardant anti-drip agent.

Each of the resin molded articles of Examples 1 to 3 in which the vinyl acetate unit content in the vinyl acetate-ethylene copolymer is from 15 mass % to 25 mass % has a higher Charpy impact strength and tensile elongation at break than each of the resin molded articles of Examples 4 and 5 in which the vinyl acetate unit content is out of such a range.

### Example 9

A predetermined resin molded article (evaluation specimen) is produced as in Example 1 except that the amount of the PC resin is changed from 70 parts by mass to 60 parts by mass and that the amount of the PET resin is changed from 30 parts by mass to 40 parts by mass.

### Example 10

A predetermined resin molded article (evaluation specimen) is produced as in Example 1 except that the amount of the PC resin is changed from 70 parts by mass to 90 parts by mass and that the amount of the PET resin is changed from 30 parts by mass to 10 parts by mass.

### Example 11

A predetermined resin molded article (evaluation specimen) is produced as in Example 1 except that the glycidyl-group-containing polyethylene polymer C-2 is used instead of the glycidyl-group-containing polyethylene polymer C-1.

### Example 12

A predetermined resin molded article (evaluation specimen) is produced as in Example 1 except that the glycidyl-group-containing polyethylene polymer C-3 is used instead of the glycidyl-group-containing polyethylene polymer C-1.

### Example 13

A predetermined resin molded article (evaluation specimen) is produced as in Example 1 except that the glycidyl-group-containing polyethylene polymer C-4 is used instead of the glycidyl-group-containing polyethylene polymer C-1.

The evaluation specimens are subjected to the tests and evaluations as in Example 1. Table 5 shows the constitution of each of the resin compositions of Examples 9 to 13 (all on a mass basis) and the results of the above-mentioned tests.

TABLE 5

| | | Example | Example | Example | Example | Example |
|---|---|---|---|---|---|---|
| | Constitution | 9 | 10 | 11 | 12 | 13 |
| Resin | PC resin | 60 | 90 | 70 | 70 | 70 |
| composition | PET resin | 40 | 10 | 30 | 30 | 30 |
| | Glycidyl-group-containing | 4 | 4 | | | |
| | polyethylene copolymer C-1 | | | | | |
| | Glycidyl-group-containing | | | 4 | | |
| | polyethylene copolymer C-2 | | | | | |
| | Glycidyl-group-containing | | | | 4 | |
| | polyethylene copolymer C-3 | | | | | |
| | Glycidyl-group-containing | | | | | 4 |
| | polyethylene copolymer C-4 | | | | | |
| | Vinyl acetate-ethylene | 1 | 1 | 1 | 1 | 1 |
| | copolymer D-1 | | | | | |
| | Flame retardant of aromatic | 15 | 15 | 15 | 15 | 15 |
| | condensed phosphate | | | | | |
| | Flame-retardant anti-drip agent | 1.0 | 1.0 | 1.0 | 1.0 | 1.0 |
| | Antioxidant | 0.2 | 0.2 | 0.2 | 0.2 | 0.2 |
| Results of | | | | | | |
| evaluations | | | | | | |
| Flame | UL94 Flame resistance | V-2 | 5VB | V-0 | V-0 | V-0 |
| resistance | (Thickness: 0.8 mm) | | | | | |
| | UL94 Flame resistance | V-0 | 5VB | 5VB | 5VB | 5VB |
| | (Thickness: 1.5 mm) | | | | | |
| Heat | DTUL (1.8 MPa) | 68.5 | 83.0 | 71.5 | 71.8 | 70.9 |
| resistance | | | | | | |
| Mechanical | Tensile strength (MPa) | 58 | 65 | 61 | 61 | 62 |
| properties | Tensile elongation at break (%) | 88 | 95 | 38 | 25 | 70 |
| | Charpy impact strength (kJ/m²) | 15 | 22 | 17 | 16 | 17 |
| Surface | Drop height: 0.7 m | AAA | AAA | AAA | AAA | AAA |
| impact | Drop height: 1.0 m | AAA | AAA | AAA | AAA | AAA |
| strength | Drop height: 1.3 m | AAA | AAA | AAA | AAA | AAA |
| | Drop height: 1.6 m | BBB | AAA | AAA | AAA | AAA |
| | Drop height: 2.0 m | CCC | AAA | AAB | AAB | AAB |
| Strength of | Drop height: 1.3 m | AAA | AAA | AAA | AAA | AAA |
| louver | Drop height: 1.6 m | BBB | AAA | AAA | AAA | AAA |
| | Drop height: 2.0 m | CCC | AAA | ACC | ABC | ABC |

As is clear from Table 5, each of the resin molded articles of Examples 9 and 10 in which the amounts of the PC resin and PET resin are from 60 parts by mass to 90 parts by mass and 10 parts by mass to 40 parts by mass, respectively, has an enhanced surface impact strength and flame resistance as compared with the resin molded article of Comparative Example 4 as in Examples 1 to 8; in addition, the surface impact strength is higher than that of each of the resin molded articles of Comparative Examples 1 to 3.

Each of the resin molded articles of Examples 11 and 12 in which the amount of the glycidyl methacrylate is from 2 parts by mass to 20 parts by mass and in which a glycidyl-group-containing polyethylene copolymer having a glass transition temperature of not more than 0° C. is used and the resin molded article of Example 13 in which a glycidyl-group-containing polyethylene copolymer in which a polymerizable vinyl monomer has been graft-polymerized with the main chain of the polyethylene copolymer is used have a higher surface impact strength and flame resistance than the resin molded article of Comparative Example 4 as in Examples 1 to 8; in addition, the surface impact strength is higher than that of each of the resin molded articles of Comparative Examples 1 to 3.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A resin composition comprising:
a polycarbonate resin;
a polyethylene terephthalate resin;
a glycidyl-group-containing polyethylene copolymer;
a vinyl acetate-ethylene copolymer;
an organic phosphorus flame retardant; and
a flame-retardant anti-drip agent, wherein
the amounts of the polycarbonate resin and polyethylene terephthalate resin are approximately from 60 mass % to 90 mass % and approximately from 10 mass % to 40 mass % relative to the total amount of the polycarbonate resin and the polyethylene terephthalate resin, respectively,
the glycidyl-group-containing polyethylene copolymer contains a glycidyl-group-containing (meth)acrylate unit and an ethylene unit,
the glycidyl-group-containing (meth)acrylate unit content in the glycidyl-group-containing polyethylene copolymer is approximately in the range of 2 mass % to 20 mass %, and
the glycidyl-group-containing polyethylene copolymer is any one of a polyethylene copolymer having a glass transition temperature of approximately not more than 0° C. and a copolymer in which a polymerizable vinyl monomer has been graft-polymerized with the main chain of a polyethylene copolymer containing a glycidyl-group-containing (meth)acrylate unit and an ethylene unit.

2. The resin composition according to claim 1, wherein the vinyl acetate unit content in the vinyl acetate-ethylene copolymer is approximately in the range of 15 mass % to 25 mass %.

3. The resin composition according to claim 1, wherein the amount of the glycidyl-group-containing polyethylene copolymer is approximately in the range of 4 mass % to 10 mass % relative to 100 parts by mass of the total amount of the polycarbonate resin and the polyethylene terephthalate resin.

4. The resin composition according to claim 1, wherein the weight average molecular weight of the polycarbonate resin is approximately from 50000 to 60000.

5. The resin composition according to claim 1, wherein the concentration of terminal hydroxyl groups in the polycarbonate resin is approximately in the range of 10 μeq/g to 15 μeq/g.

6. The resin composition according to claim 1, wherein the acid value of the polyethylene terephthalate resin is approximately from 10 eq/t to 15 eq/t.

7. A resin molded article comprising the resin composition according to claim 1.

8. A resin molded article comprising the resin composition according to claim 2.

9. A resin molded article comprising the resin composition according to claim 3.

10. A resin molded article comprising the resin composition according to claim 4.

11. A resin molded article comprising the resin composition according to claim 5.

12. A resin molded article comprising the resin composition according to claim 6.

13. A resin molded article comprising the resin composition according to claim 7.
